(19) United States
(12) Patent Application Publication
(10) Pub. No.: US 2002/0195825 A1
(43) Pub. Date: Dec. 26, 2002

(54) Bird cage door latch

(76) Inventor: Peter Yang, Taishin City (CN)

Correspondence Address: HAHN LOESER & PARKS, LLP, TWIN OAKS ESTATE, 1225 W. MARKET STREET, AKRON, OH, 44313, US

(21) Appl. No.: 09/885,412

(22) Filed: Jun. 20, 2001

(51) Int. Cl. E05C 5/00

(52) U.S. Cl. 292/63

(57) ABSTRACT

A latch for a bird cage or other container is herein described. The invention includes a latching arm rotatably and slidably mounted to a door or other wall of the cage or container. The invention further comprises a latch arm receiver where the latch arm rests when in its closed position. The invention further includes means for preventing the latch arm from rotating out of its latched position. In operation, the latch arm is rotated about a lug until it rests in the latch receiver and then is slid into a position where the arm cannot rotate.

### TECHNICAL FIELD

The present invention relates to a latch for the doors of bird cages or confining means for other small animals. Particularly, the present invention relates to a latch which is easily fastened and opened by a human, but which is not likely to accidentally unlatch and which a bird or other animal would not be able to open from inside the cage.

### BACKGROUND OF THE INVENTION

Birds and other small animals which are kept as pets are often confined to cages or other types of ventilated boxes in homes, pet stores or when travelling. When an animal is kept in a cage or box, it is necessary to keep the door or opening of the container closed so that the animal is unable to escape. Keeping such animals in such cages is important for the safety of the animal as well as humans or other animals in the area. Some pets may not have the skills or ability to survive outside of their immediate environment such that escape from the cage or other container may mean certain death for the pet. In addition, some animals may carry diseases which, though harmless to that particular animal, may be infectious to humans or other animals. Further, some pets, if allowed to roam or fly freely in a home or other environment, may simply cause messes for the human owners. For these and many other reasons, it is beneficial to keep some types of pets in confined spaces. For many animals, a simple latch mechanism, such as a hook latch, is sufficient to keep the opening to a confining container closed so that the animal cannot wander out of its cage.

Some animals however, especially birds, often have sufficient intelligence to unlatch some types of latches, such as the hook type latches. Once the latch and the door to the cage are opened, the birds may fly freely about a home or other area and may become lost, encounter dangerous conditions or create messy, unsanitary conditions in the areas where it wanders.

Although it is necessary to provide cages with a latch that the animal cannot open, it is also preferred that the latch be simple for the human caretaker of the animal to open. The human caretakers will need to open the cages to provide food and/or water to the animal, to clean the animals cage and or to let the animal out of the cage for supervised roaming or play. Thus, there is a need for a latch for a bird or other small animal cage which cannot be opened from the inside of the cage by the animal but is easily unlatched by a human.

### SUMMARY OF THE INVENTION

The present invention provides a latch for a bird or other small animal cage. The latch comprises a latching arm which is slidably and rotatably mounted to the bird cage, a latching arm receiver and a means for preventing rotation of the latching arm when it is in the latched position. In one embodiment, the latch comprises a first panel to which the arm is rotatably and slidably mounted by means of a slot in the latching arm and a lug and nut combination secured to the first panel. The first panel also includes two upwardly extending tabs on one side thereof which are spaced such that the arm may rotate so as to slide between the tabs. Once the arm is rotated and slid between the tabs, the arm is not able to rotate once it is positioned between the tabs. In addition, the present invention includes a substantially U-shaped latch arm receiver portion, which may also be mounted to a panel. The latching arm fits in the U-shaped latch arm receiver portion such that the arm rests on the bottom of the U. In the latched position, the latching arm is rotated around the lug so that it rests on the latch receiver portion. The arm is then slid so that the opposite end of the arm is between the two tabs. This prevents rotation of the arm out of the receiver until a human user slides and rotates the arm back to an open position.

### BRIEF DESCRIPTION OF THE DRAWINGS

FIGS. 1-3 show the latch of the present invention with the latching mechanism in various positions;

FIGS. 4-7 illustrate a procedure for latching and unlatching the latch of the present invention.

### DETAILED DESCRIPTION OF THE INVENTION

In the following detailed description of the preferred embodiments of the present invention, reference is made to the accompanying drawings which, in conjunction with this detailed description, illustrate and describe a latch in accordance with the present invention.

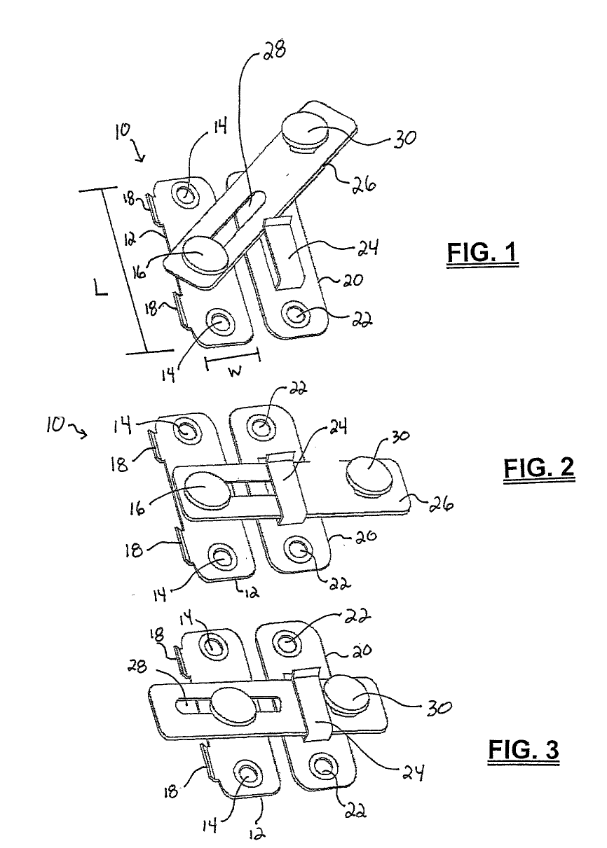

FIGS. 1-3 illustrate a latch, generally designated 10, for a bird cage or similar pet container in accordance with the present invention. In this specification all types of pet containers may be generally referred to as cages. It should be understood that this term can encompass cages, boxes, travel carriers and other types of containers in which pets may be kept. In a preferred embodiment, the latch of the present invention is fabricated of a metal such as steel, aluminum, copper, tin or alloys thereof. Alternatively, the latch may be fabricated of a rigid plastic material. The material used to form the latch should be strong enough to withstand pressure applied to the door of the cage by the animal kept therein.

Doors to cages for birds or other small animals are typically formed into a side portion or panel of the cage such that when the door is closed, the cage has a substantially uniform appearance. The door is connected to the rest of the cage at one side by a hinge which allows the door to rotate away from the body of the cage to an open position. A latch or other closure mechanism is typically connected to the side of the door opposite the hinge to hold the door in the closed position.

In the drawings and as referred to herein, the length of the panels is designated by the line marked L and the width is designated by the line marked W (FIG. 1). The height is the remaining dimension and is not labeled on the drawings.

The latch of the present invention comprises two substantially flat panel portions 12 and 20. In a preferred embodiment, the first panel portion 12, is attached of the cage door proximate to the end of the door opposite the hinge. In the case of a true “cage” the panel portion is attached to a slat in the door of the cage. The second panel portion 20 is connected to the cage adjacent to where the first panel portion 12 is located. This arrangement can be altered without departing from the scope of the present invention. Each panel portion 12 and 20 comprises at least one hole 14, 22 therein. In a preferred embodiment, the panels 12, 20 comprise two spaced holes. Panels with additional or fewer holes are within the scope of the invention. A fastening means such as a screw, nail, or a bolt with a nut on the end can be used to fasten the panels to the respective slats of the cage or a wall of the container or door of the container. The panels may alternatively have no holes and can be connected to the cage by clips, adhesives or other means.

A latching arm 26 is secured to the first panel portion 12 of the present invention. The arm 26 comprises a slot 28 therein. The arm is rotatably and slidably secured to the first panel portion 12 by a holding means 16 such as a lug or screw (generally referred to as “lug”) placed through the slot 28. The lug 16 is secured to the first panel portion 12 at its lower portion. The lower portion of the lug 16 preferably has a cylindrical shape having a diameter that is equal to or slightly smaller than the width of slot 28. This diameter allows the arm 26 to rotate and slide about the lug 16 when the lower portion of the lug is placed through slot 28. The lug 16 further includes an upper portion such as a nut to prevent the arm 26 from slipping off of the lower portion of the lug. The nut preferably has a diameter that is at least slightly greater than the diameter of the slot 28 to secure the arm to the first panel portion 12. The distance between the top surface of the first panel portion 12 and the lower surface of the nut is at least slightly greater than the height of arm, so that the arm is able to rotate substantially unencumbered around the lug 16.

The second panel portion 20 further comprises an arm receiving portion 24. In a preferred embodiment, the arm receiving portion 24 extends outwardly from the second panel portion 20 and curves upwardly substantially in a U shape relative to the second panel portion 20. The arm receiving portion extends outwardly at least a slightly greater distance than the height of the arm 26 so that the arm fits into arm receiving portion as shown in FIG. 3, 6 and 7. The second panel 20 and arm receiving portion 24 may be molded from the same piece of material such that the arm receiving portion is integral with the panel. In this embodiment, the second panel portion 20 may have an opening behind the arm receiving portion 24. Alternatively, the arm receiving portion 24 may be formed separately and be secured to the second panel portion by a variety of methods, such as molding or by using adhesives.

The first panel portion also comprises tabs 18 for preventing the movement of arm when it is in the latched position. The tabs 18 are formed into or attached to the side of the first panel 12 opposite the side which will be adjacent to the second panel 20. In a preferred embodiment, tabs 18, extend substantially upwardly from the surface of the first panel portion 20. The distance between tabs is at least equal to or slightly greater than the width of arm 26. This distance allows an end of arm to fit between the tabs so that the tabs prevent the arm from rotating out of the arm receiving portion 24 when the latch is in the “latched” or “closed” position shown in FIG. 3.

Arm 26 further comprises a handle or knob 30 at one end which facilitates moving arm between its open and closed or “latched” positions.

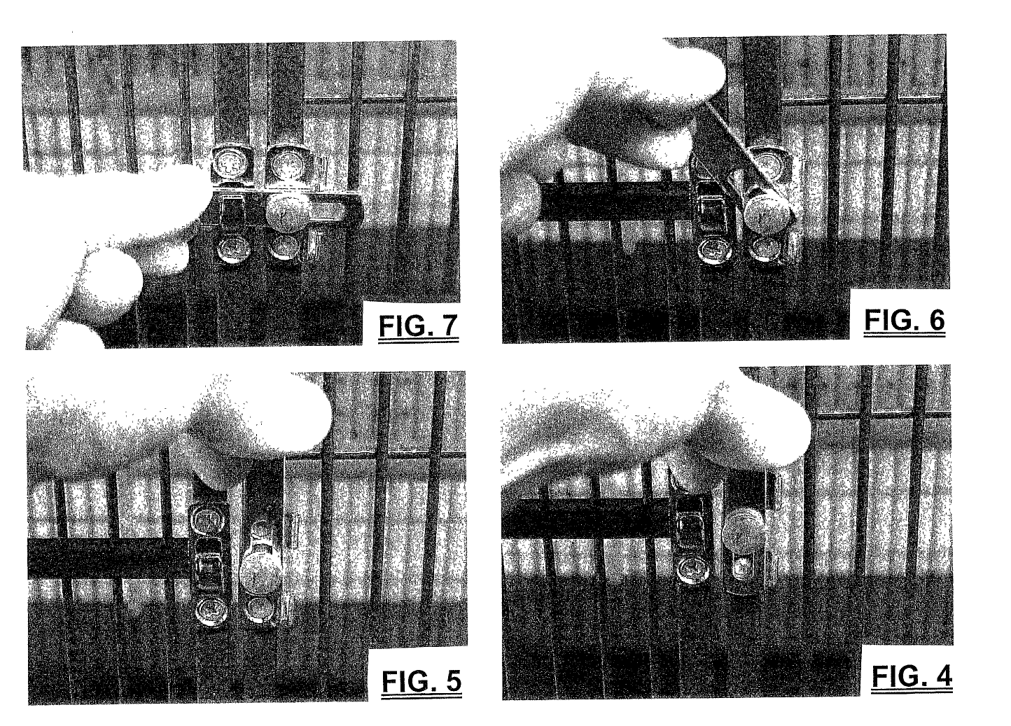

FIGS. 4-7 illustrate the “latching”or “closing”of the latch of the present invention. As shown in FIG. 4, in the “open” position, the slot 28 in the arm 26 is slid all the way down so that the top of the slot 28 rests on the lug 16. In this position, tabs 18 prevent rotation of arm 26. FIG. 5 illustrates the pulling of the arm 26 upwards so that the bottom of the slot engages lug. In this position, the arm 26 can rotate between tabs 18 as shown in FIG. 6. The arm 26 is rotated to engage the arm receiving portion 24 until arm 26 rests in arm receiving portion 24. Finally, as shown in FIG. 7, arm 26 is slid backwards through tabs, so that rotation out of the arm receiving portion out of this latched position is prevented. To open or unlatch the latch of the present invention, the above steps are reversed.

In a preferred embodiment, the first panel portion 12 which has the arm 26 mounted thereon is attached to the end of the cage door opposite the hinge. This is because the handle or knob on the arm, can be used to assist a person with opening and closing the cage door. Although this is a preferred embodiment, such an arrangement is not necessary.

The latch of the present invention is substantially precluded from being opened from the inside of the cage, because arm must be moved laterally along fastening means in order to be opened.

What is claimed is:

1. A latch comprising:
means for rotatably and slidably mounting a latching arm to a container;
means for holding said latching arm in a latched position such that it prevents a door of a container from opening;
means for preventing rotation of said latching arm when said arm is in said latched position.

2. A latch for a container comprising:
a latching arm, said latching arm having a slot therein, said slot proximate to one end of said latching arm, and being slidably and rotatably mounted to a container;
a substantially U-shaped latching arm receiver mounted adjacent to said latching arm;
a pair of tabs mounted adjacent said latching arm opposite said U-shaped latch receiver, said tabs spaced such that said latching arm is able to slide between said tabs.

3. The latch as recited in claim 2 wherein said latch is fabricated of a material selected from the group consisting of metals and rigid plastic.

4. The latch as recited in claim 2 wherein said latching arm is mounted on a panel which is secured to said container.

5. The latch as recited in claim 4 wherein said latching arm is rotatably and slidably mounted to said panel by a lug and a nut.

6. The latch as recited in claim 4 wherein said panel is secured to said container by a member selected from the group consisting of screws, bolts and nuts, and nails.

7. The latch as recited in claim 4 wherein said pair of tabs is mounted on said panel.

8. The latch as recited in claim 2 wherein said latching arm further comprises a knob secured to an end of said latching arm opposite said slot.

9. The latch as recited in claim 2 wherein said arm is rotatably and slidably secured to said container by a lug and a nut.

10. The latch as recited in claim 2 wherein said U-shaped latching arm receiver is mounted on a panel which is secured to said container.

11. A latch for a bird cage comprising:
a first panel comprising,
two spaced holes located at opposite ends of said first panel portion for fastening said first panel to said bird cage,
a lug positioned substantially equidistant between said two spaced holes,
two spaced, upwardly extending tabs on one side of said first panel;
a latching arm, wherein the width of said latching arm is at least slightly smaller than a distance between said two spaced upwardly extending tabs, said latching arm comprising,
a slot, said slot having a diameter at least slightly larger than said lug, wherein said slot rotatably and slidably engages said lug,
a nut positioned on said lug for preventing said arm from slipping off of said lug, and
a knob positioned at an end of said arm opposite said slot;
a second panel positioned adjacent to a side of said first panel opposite said tabs, said second panel comprising,
two spaced holes located at opposite ends of said second panel for fastening said second panel to said bird cage, and
a substantially U-shaped arm receiving portion located between said spaced holes.
